(19) United States
(12) Patent Application Publication
(10) Pub. No.: US 2024/0061922 A1
(43) Pub. Date: Feb. 22, 2024

(54) METHOD AND DEVICE FOR AUTHENTICATING USER

(71) Applicant: KT&G CORPORATION, Daejeon (KR)

(72) Inventors: Wonkyeong LEE, Guri-si (KR); Min Kyu KIM, Seoul (KR); Paul Joon SUNWOO, Seoul (KR)

(73) Assignee: KT&G CORPORATION, Daejeon (KR)

(21) Appl. No.: 18/270,783

(22) PCT Filed: Nov. 24, 2022
(86) PCT No.: PCT/KR2022/018670

§ 371 Date: Jul. 3, 2023

(30) Foreign Application Priority Data
Dec. 15, 2021 (KR) 10-2021-0179678

(51) Int. Cl. G06F 21/35

(52) U.S. Cl. CPC G06F 21/35

(57) ABSTRACT

To authenticate a user of an electronic device, a user terminal receives tag information including target program information from a tag device using a near-field communication (NFC) sensor, stores a target program in the user terminal based on the target program information, performs user authentication based on the target program, and transmits a result of the user authentication to the electronic device.

### TECHNICAL FIELD

One or more embodiments relate to a technology for authenticating a user of an electronic device, and more particularly, to a technology for authenticating a user using a tag having a near-field communication (NFC) function.

### BACKGROUND ART

The demand for electronic cigarettes (i.e., e-cigarettes) has recently been on the rise. The rising demand for e-cigarettes has accelerated the continued development of e-cigarette functions.

### DISCLOSURE OF THE INVENTION

### Technical Goals

An aspect provides a method of performing user authentication for a user of an electronic device by a user terminal.

Another aspect provides an unlocking method performed by an electronic device.

### Technical Solutions

According to an aspect, there is provided a user authentication method performed by a user terminal, the method including receiving tag information from a tag device using a near-field communication (NFC) sensor, the tag information comprising target program information, storing a target program in the user terminal based on the target program information, performing user authentication for a user of an electronic device based on the target program, and transmitting a result of the user authentication to the electronic device when the user indication is successful, wherein the electronic device is unlocked when the result of the user authentication is received.

The target program information may include a uniform resource locator (URL) address of the target program.

The performing the user authentication for the user of the user terminal based on the target program may include performing the user authentication using a preset authentication application programming interface (API).

The user authentication method may further include receiving a beacon transmitted by the electronic device using short-range wireless communication, and establishing a communication link with the electronic device based on the beacon.

The tag information may further include first serial information for confirming a correlation between the tag device and the electronic device.

The user authentication method may further include receiving second serial information through a user interface, and determining that the user authentication is successful based on the first serial information being identical to the second serial information.

The user authentication method may further include receiving second serial information from the electronic device via the communication link, and determining that the user authentication is successful based on the first serial information being identical to the second serial information.

The electronic device may be an electronic cigarette.

According to another aspect, there is provided a user terminal, including a memory in which a program for performing user authentication is recorded, and a processor configured to execute the program, wherein the program include instructions that cause the processor to receive tag information from a tag device using an NFC sensor, the tag information including target program information, store a target program in the user terminal based on the target program information, perform user authentication for a user of an electronic device based on the target program, and transmit a result of the user authentication to the electronic device when the user authentication is successful.

According to still another aspect, there is provided an unlocking method performed by an electronic device, the method including transmitting a beacon using short-range wireless communication, establishing a communication link with a user terminal based on a response to the beacon received from the user terminal, receiving, from the user terminal, a result of user authentication for a user of the electronic device, the result indicating that the user authentication is successful, and unlocking the electronic device when the result of the user authentication is received.

The unlocking method may further include receiving a request for serial information from the user terminal, and transmitting the serial information to the user terminal.

The unlocking the electronic device when the result of the user authentication is received may include determining whether first serial information included in the result of the user authentication is the same as second serial information of the electronic device, and unlocking the electronic device when the first serial information is the same as the second serial information.

The unlocking method may further include determining whether the user terminal is positioned around the electronic device, and locking the electronic device when the user terminal is not positioned around the electronic device.

The electronic device may be an electronic cigarette.

The unlocking method may further include determining a smoking pattern of a user using at least one sensor, determining whether the smoking pattern corresponds to a verified smoking pattern that is stored in advance, and locking the electronic device when the determined smoking pattern does not correspond to the verified smoking pattern.

### Advantageous Effects

According to example embodiments described herein, user authentication for a user of an electronic device may be performed by a user terminal.

According to example embodiments described herein, an unlocking method performed by an electronic device is provided.

### BRIEF DESCRIPTION OF DRAWINGS

FIGS. 1 through 3 are diagrams illustrating examples of insertion of a cigarette in an aerosol-generating device according to an example embodiment.

FIGS. 4 and 5 are perspective views of examples of a cigarette according to an example embodiment.

FIG. 6 is a block diagram illustrating an aerosol-generating device according to another example embodiment.

FIG. 7 is a diagram illustrating a configuration of a user authentication system according to an example embodiment.

FIG. 8 is a flowchart illustrating a user authentication method according to an example embodiment.

FIG. 9 illustrates a method of connecting a user terminal to an electronic device according to an example embodiment.

FIG. 10 is a flowchart illustrating a method of transmitting a result of user authentication to an electronic device based on serial information according to an example embodiment.

FIG. 11 is a flowchart illustrating an unlocking method based on a result of user authentication performed by an electronic device according to an example embodiment.

FIG. 12 is a flowchart illustrating a method of transmitting serial information to a user terminal according to an example embodiment.

FIG. 13 is a flowchart illustrating a method of unlocking an electronic device based on serial information according to an example embodiment.

FIG. 14 is a flowchart illustrating a method of locking an electronic device based on a position of a user terminal according to an example embodiment.

FIG. 15 is a flowchart illustrating a method of locking an electronic device based on a smoking pattern according to an example embodiment.

FIG. 16 is a diagram illustrating a configuration of a user terminal according to an example embodiment.

### BEST MODE

The following detailed structural or functional description is provided as an example only and various alterations and modifications may be made to the examples. Herein, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the embodiments with reference to the accompanying drawings, like reference numerals refer to like elements and any repeated description related thereto will be omitted.

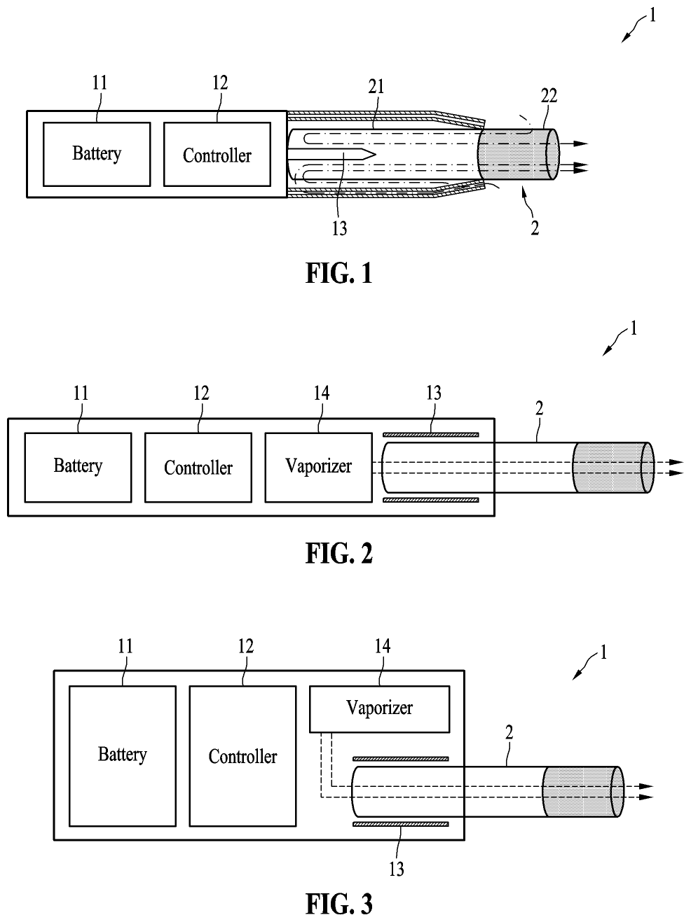

FIGS. 1 through 3 are diagrams illustrating examples of insertion of a cigarette in an aerosol-generating device according to an example embodiment.

Referring to FIG. 1, an aerosol-generating device 1 includes a battery 11, a controller 12, and a heater 13. Referring to FIGS. 2 and 3, the aerosol-generating device 1 may further include a vaporizer 14. A cigarette 2 may be inserted into an inner space of the aerosol-generating device 1. The aerosol-generating device 1 may be referred to as an electronic cigarette.

According to an example embodiment, the aerosol-generating device 1 may further include a display.

The aerosol-generating device 1 shown in FIGS. 1 through 3 may include components related to the example embodiments described herein. Therefore, it is to be understood by those of ordinary skill in the art to which the present disclosure pertains that the aerosol-generating device 1 may further include other generally used components in addition to the ones shown in FIGS. 1 through 3.

In addition, although it is shown that the heater 13 is included in the aerosol-generating device 1 in FIGS. 2 and 3, the heater 13 may be omitted as needed.

FIG. 1 illustrates a linear alignment of the battery 11, the controller 12, and the heater 13. FIG. 2 illustrates a linear arrangement of the battery 11, the controller 12, the vaporizer 14, and the heater 13. FIG. 3 illustrates a parallel arrangement of the vaporizer 14 and the heater 13. However, the internal structure of the aerosol-generating device 1 is not limited to what is shown in FIGS. 1 through 3. That is, such arrangements of the battery 11, the controller 12, the heater 13, and the vaporizer 14 may be changed depending on the design of the aerosol-generating device 1.

When the cigarette 2 is inserted into the aerosol-generating device 1, the aerosol-generating device 1 may actuate the heater 13 and/or the vaporizer 14 to generate an aerosol. The aerosol generated by the heater 13 and/or the vaporizer 14 may pass through the cigarette 2 to the user.

According to an embodiment, even when the cigarette 2 is not inserted into the aerosol-generating device 1, the aerosol-generating device 1 may heat the heater 13, as needed.

The battery 11 may supply power for operating the aerosol-generating device 1. For example, the battery 11 may supply power to heat the heater 13 or the vaporizer 14, and may supply power needed for the controller 12 to operate. In addition, the battery 11 may supply power required to operate a display, a sensor, a motor, or the like installed in the aerosol-generating device 1.

The controller 12 may control the overall operation of the aerosol-generating device 1. For example, the controller 12 may control respective operations of other components included in the aerosol-generating device 1 in addition to the battery 11, the heater 13, and the vaporizer 14. In addition, the controller 12 may verify a state of each of the components of the aerosol-generating device 1 to determine whether the aerosol-generating device 1 is in an operable state.

The controller 12 may include at least one processor. The processor may be implemented as an array of a plurality of logic gates, or may be implemented as a combination of a general-purpose microprocessor and a memory in which a program executable by the microprocessor is stored. In addition, it may be understood by those having ordinary skill in the art to which the present disclosure pertains that it may be implemented in other types of hardware.

The heater 13 may be heated by the power supplied by the battery 11. For example, when the cigarette 2 is inserted into the aerosol-generating device 1, the heater 13 may be disposed outside the cigarette 2 such that the heated heater 13 raises the temperature of an aerosol-generating material in the cigarette 2.

For example, the heater 13 may be an electrically resistive heater. In this example, the heater 13 may include an electrically conductive track, and the heater 13 may be heated as a current flows through the electrically conductive track. However, the heater 13 is not limited to the above-described example, and other types of heating the heater 13 may be heated to a desired temperature without limitation. The desired temperature may be preset in the aerosol-generating device 1 or may be set by the user.

As another example, the heater 13 may be an inductive heating-type heater. In this example, the heater 13 may include an electrically conductive coil for heating the cigarette 2 by inductive heating, and the cigarette 2 may include a susceptor to be heated by the inductive heating-type heater.

For example, the heater 13 may include a tubular heating element, a plate-shaped heating element, a needle-shaped heating element, or a rod-shaped heating element, and may heat the inside or outside of the cigarette 2 according to the shape of a heating element.

In addition, the heater 13 may be provided as a plurality of heaters in the aerosol-generating device 1. In this case, the heaters 13 may be disposed to be inserted into the cigarette 2, or may be disposed outside the cigarette 2. In addition, when the cigarette 2 is inserted in the aerosol-generating device 1, some of the heaters 13 may be inserted into the cigarette 2, and the rest may be disposed outside the cigarette 2. However, the shape of the heater 13 is not limited to what is shown in FIGS. 1 through 3 but may be provided in various shapes.

The vaporizer 14 may heat a liquid composition to generate an aerosol, and the generated aerosol may pass through the cigarette 2 to the user. That is, the aerosol generated by the vaporizer 14 may travel along an airflow path of the aerosol-generating device 1, and the airflow path may be configured such that the aerosol generated by the vaporizer 14 passes through the cigarette 2 to be provided to the user.

For example, the vaporizer 14 may include a liquid storage, a liquid transfer means, and a heating element, but is not limited thereto. For example, the liquid storage, the liquid transfer means, and the heating element may be included as independent modules in the aerosol-generating device 1.

The liquid storage may store the liquid composition. The liquid composition may be, for example, a liquid including a tobacco-containing material that includes a volatile tobacco flavor component, or may be a liquid including a non-tobacco material. The liquid storage may be detachable from the vaporizer 14, or may be manufactured integrally with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavoring ingredients, and the like, but is not limited thereto. The flavoring agent may include ingredients that provide the user with a variety of flavors or scents. The vitamin mixture may be a mixture of at least one of vitamin A, vitamin B, vitamin C, or vitamin E, but is not limited thereto. The liquid composition may also include an aerosol former such as glycerin and propylene glycol.

The liquid transfer means may transfer the liquid composition in the liquid storage to the heating element. For example, the liquid transfer means may be, but is not limited to, a wick such as cotton fiber, ceramic fiber, glass fiber, or porous ceramic.

The heating element may be an element for heating the liquid composition transferred by the liquid transfer means. The heating element may be, for example, a metal heating wire, a metal heating plate, a ceramic heater, or the like, but is not limited thereto. Further, the heating element may include a conductive filament such as a nichrome wire, and may be wound around the liquid transfer means. The heating element may be heated as a current is applied and may transfer heat to the liquid composition in contact with the heating element, heating the liquid composition. An aerosol may thereby be generated.

For example, the vaporizer 14 may be referred to as a cartomizer or an atomizer, but is not limited thereto.

The aerosol-generating device 1 may further include general-purpose components in addition to the battery 11, the controller 12, the heater 13, and the vaporizer 14. For example, the aerosol-generating device 1 may include a display that outputs visual information and/or a motor that outputs tactile information. In addition, the aerosol-generating device 1 may include at least one sensor (e.g., a puff sensor, a temperature sensor, a cigarette insertion detection sensor, etc.). In addition, the aerosol-generating device 1 may be manufactured to have a structure in which external air may be introduced or internal gas may flow out even with the cigarette 2 being inserted.

Although not shown in FIGS. 1 through 3, the aerosol-generating device 1 may form a system along with a separate cradle. For example, the cradle may be used for charging the battery 11 of the aerosol-generating device 1. Alternatively, the cradle may be used to heat the heater 13 while the aerosol-generating device 1 is coupled to the cradle.

The cigarette 2 may be similar to one of a general burning type cigarette. For example, the cigarette 2 may include a first portion including an aerosol-generating material and a second portion including a filter or the like. Alternatively, the second portion of the cigarette 2 may also include the aerosol-generating material. For example, an aerosol-generating material made in the form of granules or capsules may be inserted into the second portion.

The first portion may be entirely inserted into the aerosol-generating device 1, and the second portion may be exposed outside. Alternatively, the first portion may be partially inserted into the aerosol-generating device 1, or the first portion and the second portion may be inserted entirely and partially, respectively, into the aerosol-generating device 1. The user may then inhale an aerosol with the second portion in their mouth. In this case, the aerosol may be generated as external air passes through the first portion, and the generated aerosol may pass through the second portion to be into the mouth of the user.

For example, the external air may be introduced through at least one air passage formed in the aerosol-generating device 1. In this example, the air passage formed in the aerosol-generating device 1 may be adjusted in the opening or closing and/or in the size by the user. Accordingly, an amount of atomization, a sense of smoking, or the like may be adjusted by the user. As another example, the external air may be introduced into the inside of the cigarette 2 through at least one hole formed on a surface of the cigarette 2.

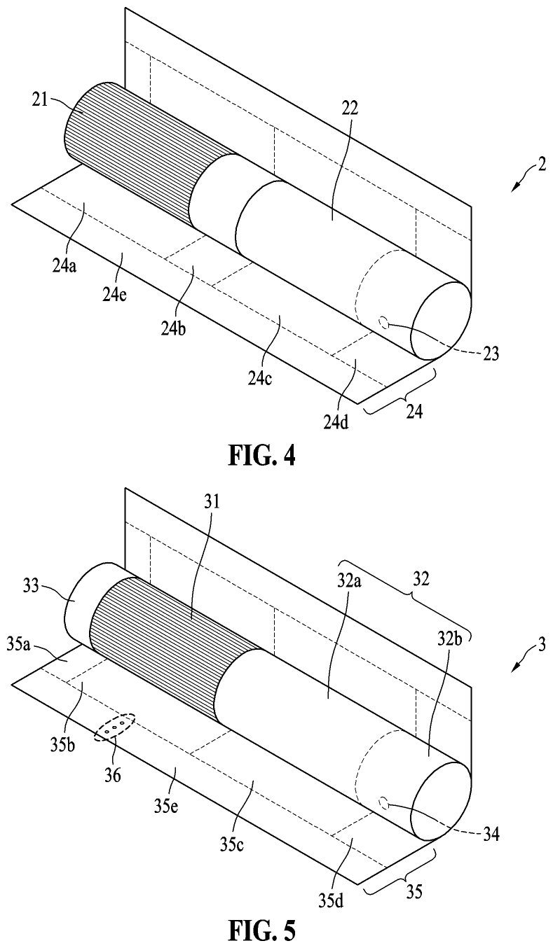

Hereinafter, examples of the cigarette 2 will be described with reference to FIGS. 4 and 5.

FIGS. 4 and 5 are perspective views of examples of a cigarette according to an example embodiment.

Referring to FIG. 4, the cigarette 2 may include a tobacco rod 21 and a filter rod 22. The first portion and the second portion described above with reference to FIGS. 1 through 3 may include the tobacco rod 21 and the filter rod 22, respectively.

Although the filter rod 22 is illustrated as having a single segment in FIG. 4, embodiments are not limited thereto. That is, the filter rod 22 may include a plurality of segments. For example, the filter rod 22 may include a segment that cools an aerosol and a segment that filters out certain components contained in the aerosol. In addition, the filter rod 22 may further include at least one segment that performs another function, as needed.

A diameter of the cigarette 2 may be in a range of 5 millimeters (mm) to 9 mm, and a length thereof may be approximately 48 mm. However, the cigarette 2 is not limited thereto. For example, a length of the tobacco rod 21 may be approximately 12 mm, a length of a first segment of the filter rod 22 may be approximately 10 mm, a length of a second segment of the filter rod 22 may be approximately 14 mm, and a length of a third segment of the filter rod 22 may be approximately 12 mm. However, examples are not limited thereto.

The cigarette 2 may be wrapped with at least one wrapper 24. The wrapper 24 may have at least one hole through which external air is introduced or internal gas is discharged outside. For example, the cigarette 2 may be wrapped with one wrapper 24. As another example, the cigarette 2 may be wrapped with two or more wrappers 24 in an overlapping manner. For example, the tobacco rod 21 may be wrapped with a first wrapper 24a, and the filter rod 22 may be wrapped with wrappers 24b, 24c, and 24d. In addition, the cigarette 2 may be entirely wrapped again with a single wrapper 24e. For example, when the filter rod 22 includes a plurality of segments, the segments may be wrapped with the wrappers 24b, 24c, and 24d, respectively.

The first wrapper 24a and the second wrapper 24b may be formed of a general filter wrapping paper. For example, the first wrapper 24a and the second wrapper 24b may be porous wrapping paper or non-porous wrapping paper. In addition, the first wrapper 24a and the second wrapper 24b may be formed of oil-proof paper and/or an aluminum laminated wrapping material.

The third wrapper 24c may be formed of hard wrapping paper. For example, a basis weight of the third wrapper 24c may be in a range of 88 grams per square meter (g/m²) to 96 g/m², and may be desirably in a range of 90 g/m² to 94 g/m². In addition, a thickness of the third wrapper 24c may be in a range of 120 micrometers (μm) to 130 μm, and may be desirably 125 μm.

The fourth wrapper 24d may be formed of oil-proof hard wrapping paper. For example, a basis weight of the fourth wrapper 24d may be in a range of 88 g/m² to 96 g/m², and may be desirably in a range of 90 g/m² to 94 g/m². In addition, a thickness of the fourth wrapper 24d may be in a range of 120 μm to 130 μm, and may be desirably 125 μm.

The fifth wrapper 24e may be formed of sterile paper (e.g., MFW). The sterilized paper (MFW) refers to paper specially prepared to enhance tensile strength, water resistance, smoothness, or the like, compared to general paper. For example, a basis weight of the fifth wrapper 24e may be in a range of 57 g/m² to 63 g/m², and may be desirably 60 g/m². In addition, a thickness of the fifth wrapper 24e may be in a range of 64 μm to 70 μm, and may be desirably 67 μm.

The fifth wrapper 24e may have a predetermined material internally added thereto. The material may be, for example, silicon, but is not limited thereto. Silicon may have properties, such as, for example, heat resistance with less change by temperature, oxidation resistance, resistance to various chemicals, water repellency against water, or electrical insulation. However, silicon may not be necessarily used, but any material having such properties described above may be applied (or coated) on the fifth wrapper 24e without limitation.

The fifth wrapper 24e may prevent the cigarette 2 from burning. For example, when the tobacco rod 21 is heated by the heater 13, the cigarette 2 may be likely to burn. For example, when the temperature rises above an ignition point of any one of the materials included in the tobacco rod 21, the cigarette 2 may burn. Even in this case, it may still be possible to prevent the cigarette 2 from burning because the fifth wrapper 24e includes a non-combustible material.

In addition, the fifth wrapper 24e may prevent a holder from being contaminated by substances produced in the cigarette 2. For example, liquid substances may be produced in the cigarette 2 by puffs from the user. For example, as an aerosol generated in the cigarette 2 is cooled by external air, such liquid substances (e.g., water, etc.) may be produced. Thus, wrapping the cigarette 2 with the fifth wrapper 24e may prevent the liquid substances produced in the cigarette 2 from leaking out of the cigarette 2.

The tobacco rod 21 may include an aerosol-generating material. The aerosol-generating material may include, for example, at least one of glycerin, propylene glycol, ethylene glycol, dipropylene glycol, diethylene glycol, triethylene glycol, tetraethylene glycol, or oleyl alcohol, but is not limited thereto. The tobacco rod 21 may also include other additives, such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be manufactured as a sheet or as a strand. The tobacco rod 21 may also be formed with a cut tobacco filler from finely cut tobacco sheets. In addition, the tobacco rod 21 may be enveloped by a heat-conductive material. The heat-conductive material may be, for example, a metal foil such as an aluminum foil, but is not limited thereto. For example, the heat-conductive material enveloping the tobacco rod 21 may evenly distribute the heat transferred to the tobacco rod 21 to improve the thermal conductivity to be applied to the tobacco rod 21, thereby improving the taste of tobacco. In addition, the heat-conductive material enveloping the tobacco rod 21 may function as a susceptor heated by an inductive heater. In this case, although not shown, the tobacco rod 21 may further include an additional susceptor in addition to the heat-conductive material enveloping the outside.

The filter rod 22 may be a cellulose acetate filter. However, the shape of the filter rod 22 is not limited. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

In this example, a first segment of the filter rod 22 may be a cellulose acetate filter. For example, the first segment may be a tubular structure including a hollow therein. In this example, the first segment may prevent internal materials of the tobacco rod 21 from being pushed back when the heater 13 is inserted and generate an aerosol cooling effect. A desirable diameter of the hollow included in the first segment may be adopted from a range of 2 mm to 4.5 mm, but is not limited thereto.

A desirable length of the first segment may be adopted from a range of 4 mm to 30 mm, but is not limited thereto. The length of the first segment may be desirably 10 mm, but is not limited thereto.

The first segment may have a certain hardness that is adjusted by adjusting the plasticizer content in a process of manufacturing the first segment. In addition, a structure such as a film or a tube of the same or different material may be included in the first segment.

A second segment of the filter rod 22 may cool an aerosol generated as the heater 13 heats the tobacco rod 21. The user may thus inhale the aerosol cooled down to a suitable temperature.

A length or diameter of the second segment may be determined in various ways according to the shape of the cigarette 2. For example, a desirable length of the second segment may be adopted from a range of 7 mm to 20 mm. The length of the second segment may be desirably approximately 14 mm, but is not limited thereto.

The second segment may be manufactured by weaving polymer fiber. In this case, a flavoring liquid may be applied to the fiber formed of a polymer. Alternatively, the second segment may be manufactured by weaving a separate fiber to which a flavoring liquid is applied and the fiber formed of the polymer together. Alternatively, the second segment may be formed with a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA,) and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed from a material having a thickness between approximately 5 m and approximately 300 μm, for example, between approximately 10 m and approximately 250 m. In addition, a total surface area of the second segment may be between approximately 300 mm²/mm and approximately 1000 mm²/mm. Further, an aerosol cooling element may be formed from a material having a specific surface area between approximately 10 mm²/mg and approximately 100 m² mm²/mg.

The second segment may include a thread containing a volatile flavor ingredient. The volatile flavor ingredient may be menthol, but is not limited thereto. For example, the thread may be filled with a sufficient amount of menthol to provide at least 1.5 milligrams (mg) of menthol to the second segment.

A third segment of the filter rod 22 may be a cellulose acetate filter. A desirable length of the third segment may be adopted from a range of 4 mm to 20 mm. For example, the length of the third segment may be approximately 12 mm, but is not limited thereto.

The third segment may be manufactured such that a flavor is generated by spraying a flavoring liquid onto the third segment in a process of manufacturing the third segment. Alternatively, a separate fiber to which the flavoring liquid is applied may be inserted into the third segment. An aerosol generated by the tobacco rod 21 may be cooled as it passes through the second segment of the filter rod 22, and the cooled aerosol may pass through the third segment to the user. Accordingly, when a flavoring element is added to the third segment, the durability of the flavor to be delivered to the user may be enhanced.

In addition, the filter rod 22 may include at least one capsule 23. The capsule 23 may perform a function of generating a flavor, or a function of generating an aerosol. For example, the capsule 23 may be of a structure in which a liquid containing a fragrance is wrapped with a film. The capsule 23 may have a spherical or cylindrical shape, but is not limited thereto.

Referring to FIG. 5, a cigarette 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied from the tobacco rod 31 during smoking from flowing into an aerosol-generating device (e.g., the aerosol-generating device 1 of FIGS. 1 through 3).

The filter rod 32 may include a first segment 32a and a second segment 32b. The first segment 32a may correspond to the first segment of the filter rod 22 of FIG. 4, and the second segment 32b may correspond to the third segment of the filter rod 22 of FIG. 4.

A diameter and a total length of the cigarette 3 may correspond to the diameter and the total length of the cigarette 2 of FIG. 4. For example, a length of the front end plug 33 may be approximately 7 mm, a length of the tobacco rod 31 may be approximately 15 mm, a length of the first segment 32a may be approximately 12 mm, and a length of the second segment 32b may be approximately 14 mm. However, the examples are not limited thereto.

The cigarette 3 may be wrapped with at least one wrapper 35. The wrapper 35 may have at least one hole through which external air flows inside or internal gas flows outside. For example, the front end plug 33 may be wrapped with a first wrapper 35a, the tobacco rod 31 may be wrapped with a second wrapper 35b, the first segment 32a may be wrapped with a third wrapper 35c, and the second segment 32b may be wrapped with a fourth wrapper 35d. In addition, the cigarette 3 may be entirely wrapped again with a fifth wrapper 35e.

In addition, at least one perforation 36 may be formed on the fifth wrapper 35e. For example, the perforation 36 may be formed in an area surrounding the tobacco rod 31, but is not limited thereto. The perforation 36 may perform a function of transferring heat generated by the heater 13 shown in FIGS. 2 and 3 to the inside of the tobacco rod 31.

In addition, the second segment 32b may include at least one capsule 34. The capsule 34 may perform a function of generating a flavor or a function of generating an aerosol. For example, the capsule 34 may have a structure in which a liquid containing a fragrance is wrapped with a film. The capsule 34 may have a spherical or cylindrical shape, but is not limited thereto.

The first wrapper 35a may be a combination of general filter wrapping paper and a metal foil such as an aluminum foil. For example, a total thickness of the first wrapper 35a may be in a range of 45 μm to 55 μm, and may be desirably 50.3 μm. In addition, a thickness of the metal foil of the first wrapper 35a may be in a range of 6 μm to 7 μm, and may be desirably 6.3 μm. In addition, a basis weight of the first wrapper 35a may be in a range of 50 g/m² to 55 g/m², and may be desirably 53 g/m².

The second wrapper 35b and the third wrapper 35c may be formed with general filter wrapping paper. The second wrapper 35b and the third wrapper 35c may each be, for example, porous wrapping paper or non-porous wrapping paper.

For example, a porosity of the second wrapper 35b may be 35000 CU, but is not limited thereto. In addition, a thickness of the second wrapper 35b may be in a range of 70 μm to 80 μm, and may be desirably 78 μm. In addition, a basis weight of the second wrapper 35b may be in a range of 20 g/m² to 25 g/m², and may be desirably 23.5 g/m².

For example, a porosity of the third wrapper 35c may be 24000 CU, but is not limited thereto. In addition, a thickness of the third wrapper 35c may be in a range of 60 μm to 70 μm, and may be desirably 68 μm. In addition, a basis weight of the third wrapper 35c may be in a range of 20 g/m² to 25 g/m², and may be desirably 21 g/m².

The fourth wrapper 35d may be formed with PLA laminated paper. The PLA laminated paper may refer to three-ply paper including a paper layer, a PLA layer, and a paper layer. For example, a thickness of the fourth wrapper 35d may be in a range of 100 μm to 120 μm, and may be desirably 110 μm. In addition, a basis weight of the fourth wrapper 35d may be in a range of 80 g/m² to 100 g/m², and may be desirably 88 g/m².

The fifth wrapper 35e may be formed of sterile paper (e.g., MFW). The sterile paper (MFW) may refer to paper specially prepared such that it has enhanced tensile strength, water resistance, smoothness, or the like, compared to those of general paper. For example, a basis weight of the fifth wrapper 35e may be in a range of 57 g/m² to 63 g/m², and may be desirably 60 g/m². In addition, a thickness of the fifth wrapper 35e may be in a range of 64 μm to 70 μm, and may be desirably 67 μm.

The fifth wrapper 35e may have a predetermined material internally added thereto. The material may be, for example, silicon, but is not limited thereto. Silicon may have properties, such as, for example, heat resistance with less change by temperature, oxidation resistance, resistance to various chemicals, water repellency against water, or electrical insulation. However, silicon may not be necessarily used, but any material having such properties described above may be applied (or coated) to the fifth wrapper 35e without limitation.

The front end plug 33 may be formed of cellulose acetate. For example, the front end plug 33 may be manufactured by adding a plasticizer (e.g., triacetin) to cellulose acetate tow. A mono denier of a filament constituting the cellulose acetate tow may be in a range of 1.0 to 10.0, and may be desirably in a range of 4.0 to 6.0. The mono denier of the filament of the front end plug 33 may be more desirably 5.0. In addition, a cross section of the filament constituting the front end plug 33 may be Y-shaped. A total denier of the front end plug 33 may be in a range of 20000 to 30000, and may be desirably in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted here.

The first segment 32a may be formed of cellulose acetate. For example, the first segment 32a may be a tubular structure including a hollow therein. The first segment 32a may be manufactured by adding a plasticizer (e.g., triacetin) to cellulose acetate tow. For example, a mono denier and a total denier of the first segment 32a may be the same as the mono denier and the total denier of the front end plug 33.

The second segment 32b may be formed of cellulose acetate. A mono denier of a filament constituting the second segment 32b may be in a range of 1.0 to 10.0, and may be desirably in a range of 8.0 to 10.0. The mono denier of the filament of the second segment 32b may be more desirably 9.0. In addition, a cross section of the filament of the second segment 32b may be Y-shaped. A total denier of the second segment 32b may be in a range of 20000 to 30000, and may be desirably 25000.

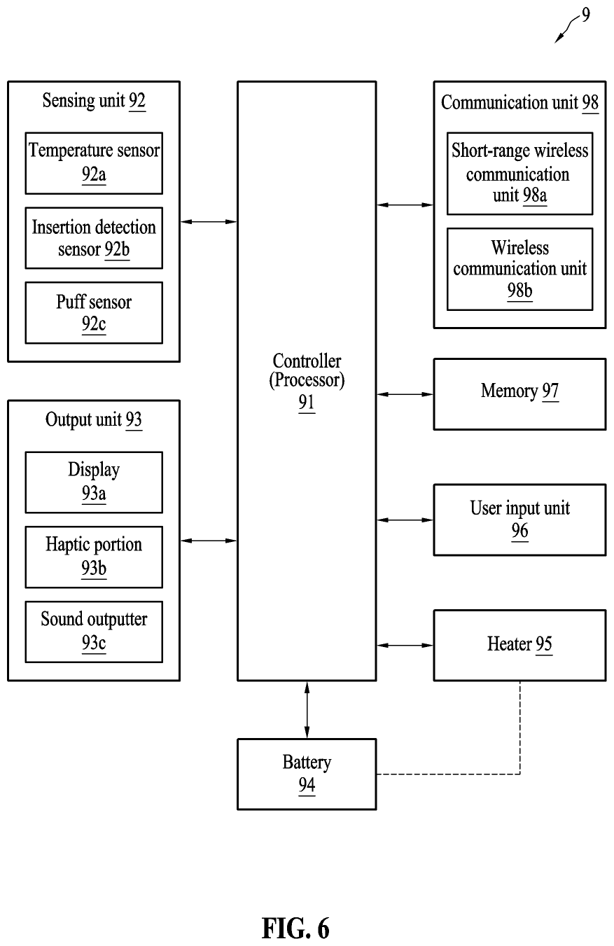

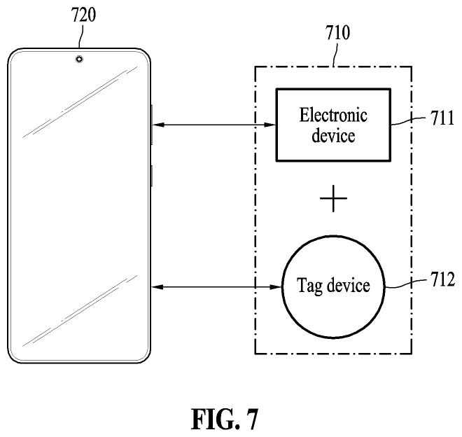

FIG. 6 is a block diagram illustrating an aerosol-generating device according to another example embodiment.

According to an example embodiment, the aerosol-generating device 9 may include a controller 91, a sensing unit 92, an output unit 93, a battery 94, a heater 95, a user input unit 96, a memory 97, and a communication unit 98. However, an internal structure of the aerosol-generating device 9 is not limited to what is shown in FIG. 6. It is to be understood by those having ordinary skill in the art to which the present disclosure pertains that some of the components shown in FIG. 6 may be omitted or new components may be added according to the design of the aerosol-generating device 9.

The sensing unit 92 may sense a state of the aerosol-generating device 9 or a state of an environment around the aerosol-generating device 9, and transmit sensing information obtained through the sensing to the controller 91. Based on the sensing information, the controller 91 may control the aerosol-generating device 9 to control operations of the heater 95, restrict smoking, determine whether an aerosol-generating item (e.g., a cigarette, a cartridge, etc.) is inserted, display a notification, and perform other functions.

The sensing unit 92 may include at least one of a temperature sensor 92a, an insertion detection sensor 92b, or a puff sensor 92c, but is not limited thereto.

The temperature sensor 92a may sense a temperature at which the heater 95 (or an aerosol-generating material) is heated. The aerosol-generating device 9 may include a separate temperature sensor for sensing a temperature of the heater 95, or the heater 95 itself may perform a function as a temperature sensor. Alternatively, the temperature sensor 92a may be arranged around the battery 94 to monitor a temperature of the battery 94.

The insertion detection sensor 92b may sense whether the aerosol-generating item is inserted or removed. The insertion detection sensor 92b may include, for example, at least one of a film sensor, a pressure sensor, a light sensor, a resistive sensor, a capacitive sensor, an inductive sensor, or an infrared sensor, which may sense a signal change by the insertion or removal of the aerosol-generating item.

The puff sensor 92c may sense a puff from a user based on various physical changes in an airflow path or airflow channel. For example, the puff sensor 92c may sense the puff based on any one of a temperature change, a flow change, a voltage change, and a pressure change.

The sensing unit 92 may further include at least one of a temperature/humidity sensor, a barometric pressure sensor, a magnetic sensor, an acceleration sensor, a gyroscope sensor, a position sensor (e.g., a global positioning system (GPS)), a proximity sensor, and a red, green, blue (RGB) sensor (e.g., an illuminance sensor), in addition to the sensors 92a through 92c described above. A function of each sensor may be intuitively inferable from its name by those having ordinary skill in the art, and thus a more detailed description thereof will be omitted here.

The output unit 93 may output information about the state of the aerosol-generating device 9 and provide the information to the user. The output unit 93 may include at least one of a display 93a, a haptic portion 93b, or a sound outputter 93c, but is not limited thereto. When the display 93a and a touchpad are provided in a layered structure to form a touchscreen, the display 93a may be used as an input device in addition to an output device.

The display 93a may visually provide the information about the aerosol-generating device 9 to the user. The information about the aerosol-generating device 9 may include, for example, a charging/discharging state of the battery 94 of the aerosol-generating device 9, a preheating state of the heater 95, an insertion/removal state of the aerosol-generating item, a limited usage state (e.g., an abnormal item detected) of the aerosol-generating device 9, or the like, and the display 93a may externally output the information. The display 93a may be, for example, a liquid-crystal display panel (LCD), an organic light-emitting display panel (OLED), or the like. The display 93a may also be in the form of a light-emitting diode (LED) device.

The haptic portion 93b may provide the information about the aerosol-generating device 9 to the user in a haptic way by converting an electrical signal into a mechanical stimulus or an electrical stimulus. The haptic portion 93b may include, for example, a motor, a piezoelectric element, or an electrical stimulation device.

The sound outputter 93c may provide the information about the aerosol-generating device 9 to the user in an auditory way. For example, the sound outputter 93c may convert an electric signal into a sound signal and externally output the sound signal.

The battery 94 may supply power to be used to operate the aerosol-generating device 9. The battery 94 may supply power to heat the heater 95. In addition, the battery 94 may supply power required for operations of the other components (e.g., the sensing unit 92, the output unit 93, the user input unit 96, the memory 97, and the communication unit 98) included in the aerosol-generating device 9. The battery 94 may be a rechargeable battery or a disposable battery. The battery 94 may be, for example, a lithium polymer (LiPoly) battery, but is not limited thereto.

The heater 95 may receive power from the battery 94 to heat the aerosol-generating material. Although not shown in FIG. 6, the aerosol-generating device 9 may further include a power conversion circuit (e.g., a direct current (DC)-to-DC (DC/DC) converter) that converts power of the battery 94 and supplies the power to the heater 95. In addition, when the aerosol-generating device 9 generates an aerosol by an inductive heating method, the aerosol-generating device 9 may further include a DC-to-alternating current (AC) (DC/AC) converter that converts DC power of the battery 94 into AC power.

The controller 91, the sensing unit 92, the output unit 93, the user input unit 96, the memory 97, and the communication unit 98 may receive power from the battery 94 to perform functions. Although not shown in FIG. 6, the aerosol-generating device 9 may further include a power conversion circuit, for example, a low dropout (LDO) circuit or a voltage regulator circuit, that converts power of the battery 94 and supplies the power to respective components.

According to an example embodiment, the heater 95 may be formed of an electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 95 may be implemented as a metal heating wire, a metal heating plate on which an electrically conductive track is arranged, a ceramic heating element, or the like, but is not limited thereto.

According to another example embodiment, the heater 95 may be an inductive heating-type heater. For example, the heater 95 may include a susceptor that heats the aerosol-generating material by generating heat through a magnetic field applied by a coil.

According to an example embodiment, the heater 95 may include a plurality of heaters. For example, the heater 95 may include a first heater for heating a cigarette and a second heater for heating a liquid.

The user input unit 96 may receive information input from the user or may output information to the user. For example, the user input unit 96 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like, but is not limited thereto. In addition, although not shown in FIG. 6, the aerosol-generating device 9 may further include a connection interface such as a universal serial bus (USB) interface, and may be connected to another external device through the connection interface such as a USB interface to transmit and receive information or to charge the battery 94.

The memory 97, which is hardware for storing various pieces of data processed in the aerosol-generating device 9, may store data processed by the controller 91 and data to be processed thereby. The memory 97 may include a storage medium of at least one type among, for example, a flash memory type, a hard disk type, a multimedia card micro type, a card type memory (e.g., an SD or xD memory), a random-access memory (RAM), a static RAM (SRAM), a read-only memory (ROM), an electrically erasable programmable ROM (EEPROM), a programmable ROM (PROM), a magnetic memory, a magnetic disk, or an optical disc. The memory 97 may store an operating time of the aerosol-generating device 9, a maximum number of puffs, a present number of puffs, at least one temperature profile, data associated with a smoking pattern of the user, or the like.

The communication unit 98 may include at least one component for communicating with another electronic device. For example, the communication unit 98 may include a short-range communication unit 98a and a wireless communication unit 98b.

The short-range wireless communication unit 98a may include a Bluetooth communication unit, a Bluetooth low energy (BLE) communication unit, a near-field communication (NFC) unit, a wireless local area network (WLAN) (or Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, or the like. However, the examples of which are not limited thereto.

The wireless communication unit 98b may include a cellular network communication unit, an Internet communication unit, a computer network (e.g., a local area network (LAN) or a wide-area network (WAN)) communication unit, or the like. However, examples of which are not limited thereto. The wireless communication unit 98b may use subscriber information (e.g., international mobile subscriber identity (IMSI)) to identify and authenticate the aerosol-generating device 9 in a communication network.

The controller 91 may control an overall operation of the aerosol-generating device 9. According to an example embodiment, the controller 91 may include at least one processor. The processor may be implemented as an array of a plurality of logic gates, or may be implemented as a combination of a general-purpose microprocessor and a memory in which a program executable by the microprocessor is stored. In addition, it may be understood by those having ordinary skill in the art to which the present disclosure pertains that it may be implemented in other types of hardware.

The controller 91 may control the temperature of the heater 95 by controlling the supply of power from the battery 94 to the heater 95. For example, the controller 91 may control the supply of power by controlling switching of a switching element between the battery 94 and the heater 95. As another example, a direct heating circuit may control the supply of power to the heater 95 according to a control command from the controller 91.

The controller 91 may analyze a sensing result obtained by the sensing of the sensing unit 92 and control processes to be performed thereafter. For example, the controller 91 may control power to be supplied to the heater 95 to start or end an operation of the heater 95 based on the sensing result obtained by the sensing unit 92. Also, the controller 91 may control an amount of power to be supplied to the heater 95 and a time for which the power is to be supplied, such that the heater 95 may be heated up to a predetermined temperature or maintained at a desirable temperature, based on the sensing result of the sensing unit 92.

The controller 91 may control the output unit 93 based on the sensing result of the sensing unit 92. For example, when the number of puffs counted through the puff sensor 92c reaches a preset number, the controller 91 may inform the user that the aerosol-generating device 9 is to be ended soon, through at least one of the display 93a, the haptic portion 93b, or the sound outputter 93c.

According to an example embodiment, the controller 91 may control a power supply time and/or a power supply amount for the heater 95 according to a state of the aerosol-generating item sensed by the sensing unit 92. For example, when the aerosol-generating item is in an over-humidified state, the controller 91 may control the power supply time for an inductive coil to increase a preheating time, compared to a case where an aerosol-generating item is in a general state.

FIG. 7 is a diagram illustrating a configuration of a user authentication system according to an example embodiment.

According to an example embodiment, in a method of authenticating a user of an aerosol-generating device, a Bluetooth module is mounted on the aerosol-generating device such that user authentication may be performed by an application of a mobile phone via communication with a user terminal (e.g., mobile phone). According to an example embodiment, an application for performing the user authentication method using an NFC tag may be easily installed in the user terminal.

According to an example embodiment, the user authentication system may include an electronic device set 710 and a user terminal 720. The electronic device set 710 may include, for example, an electronic device 711 (e.g., the aerosol-generating device 1 of FIG. 1 or the aerosol-generating device 9 of FIG. 6) and a tag device 712. For example, the user terminal 720 may be a mobile communication terminal. The structure of the user terminal 720 will be described in detail below with reference to FIG. 16.

According to an example embodiment, the tag device 712 may include program information that may be read by an NFC sensor of the user terminal 720. For example, the program information may be data of a target program that may be stored (or installed) in the user terminal 720. As another example, the program information may be a target uniform resource locator (URL) address where data of the target program is stored. The target program may be used to unlock the electronic device 711.

According to an example embodiment, the tag device 712 may be included in a packaging of the electronic device 711. That is, the tag device 712 and the electronic device 711 may be sold together as a package. For example, the tag device 712 may be a separate device that is attachable to and detachable from the electronic device 711. As another example, the tag device 712 may be included in the electronic device 711 so as not to be exposed to the outside.

According to an example embodiment, the electronic device 711 may be locked prevent unauthorized use, and the electronic device 711 may be unlocked only when a user of the electronic device 711 performs the user authentication (e.g., adult authentication). The user authentication may be performed by the target program executed by the user terminal 720, and when the electronic device 711 receives a result of the successful user authentication from the user terminal 720, the electronic device 711 may be unlocked.

The electronic device 711 may be sold together with the tag device 712 to implement user authentication of the electronic device 711. That is, since the tag device 712 is used to unlock the electronic device 711, the electronic device 711 and the tag device 712 may be sold as a package.

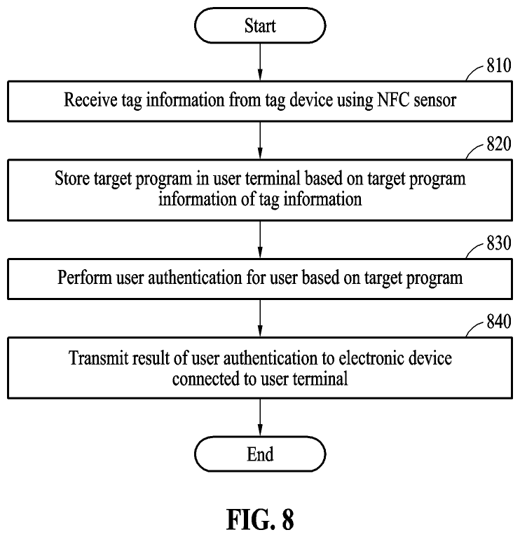

A method of unlocking the electronic device 711 will be described in detail below with reference to FIGS. 8 through 16.

FIG. 8 is a flowchart illustrating a user authentication method according to an example embodiment.

Operations 810 through 840 described below may be performed by the user terminal 720 described above with reference to FIG. 7.

In operation 810, the user terminal 720 may receive tag information from the tag device 712 using the NFC sensor of the user terminal 720. The tag information may include target program information. The target program information may be, for example, data of the target program. As another example, the target program information may be a URL address where the data of the target program is stored.

According to an example embodiment, the tag information may further include first serial information. The first serial information may be used to identify the electronic device 711 corresponding to the tag device 712. For example, the first serial information may be used to confirm a correlation between the tag device 712 and the electronic device 711. The serial information may be unique information.

According to an example embodiment, the tag information may further include various pieces of information. For example, the tag information may include a user manual for the electronic device 711, service center information, a URL address of an online shop, and the like.

In operation 820, the user terminal 720 may store (or install) the target program in the user terminal based on the target program information of the tag information. For example, the user terminal 720 may read data of the target program directly from the tag device 712 and install the target program in the user terminal 720 using the read data of the target program. As another example, the user terminal 720 may access the target URL address indicated by the target program information, download data of the target program stored at the target URL address, and install the target program in the user terminal 720 using the downloaded data of the target program. The target program may be a program for authenticating a user of the user terminal 720 (e.g., adult authentication).

In operation 830, the user terminal 720 may perform the user authentication for the user based on the target program.

According to an example embodiment, the user terminal 720 may perform the user authentication using an authentication application programming interface (API) preset in the target program. A method of performing the user authentication is not limited to the example embodiment described herein.

In operation 840, the user terminal 720 may transmit a result of the user authentication to the electronic device 711 connected to the user terminal 720. For example, the user terminal 720 may be connected to the electronic device 711 through short-range wireless communication. A method of connecting the user terminal 720 to the electronic device 711 will be described in detail below with reference to FIG. 8.

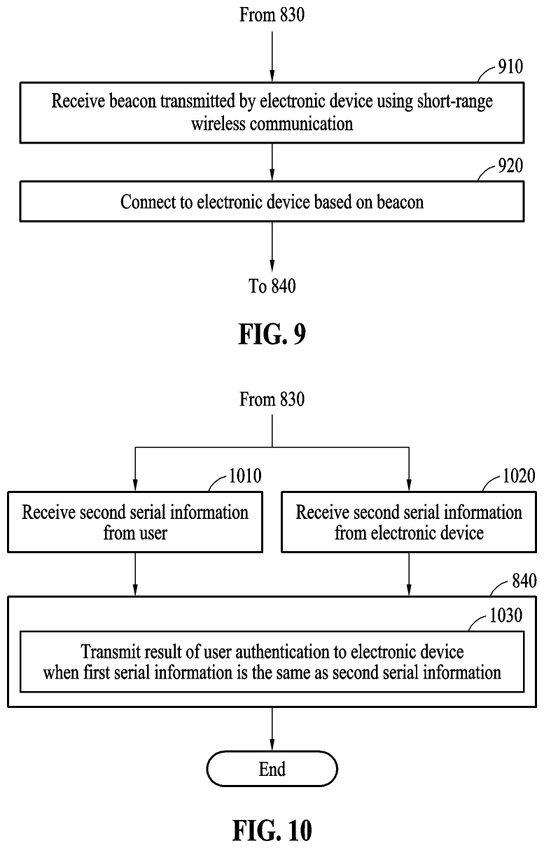

FIG. 9 illustrates a method of connecting a user terminal to an electronic device according to an example embodiment.

According to an example embodiment, operations 910 and 920 may be further performed between operation 830 and operation 840 shown in FIG. 8, but embodiments are not limited thereto.

In operation 910, the user terminal 720 may receive a beacon transmitted by the electronic device 711 using short-range wireless communication. The short-range wireless communication may be, for example, Bluetooth. The user terminal 720 may receive a beacon by scanning a frequency band preset for Bluetooth.

In operation 920, the user terminal 720 may be connected to the electronic device 711 based on the beacon. For example, the user terminal 720 may establish a communication link (or a channel) between the user terminal 720 and the electronic device 711.

FIG. 10 is a flowchart illustrating a method of transmitting a result of user authentication to an electronic device based on serial information according to an example embodiment.

According to an example embodiment, the user terminal 720 may transmit a result of the user authentication to the electronic device 711 only when the electronic tag 712 and the electronic device 711 correspond to each other. For the above-described example embodiment, operation 1010 or 1020 described below may be further performed. Thus, operations 1010 and 1020 may be performed selectively.

In operation 1010, the user terminal 720 may receive second serial information from the user. For example, the user may input serial information displayed on the electronic device 711 to the user terminal 720.

In operation 1020, the user terminal 720 may receive the second serial information from the electronic device 711. For example, the user terminal 720 may receive the second serial information via the connection between the user terminal 720 and the electronic device 711. The electronic device 711 may transmit serial information set in the electronic device 711 to the user terminal 720 according to a request from the user terminal 720.

In operation 1030, the user terminal 720 may determine that user authentication is successful and transmit a result of the user authentication to the electronic device 711 when the first serial information obtained from the tag device 712 is the same as (or corresponds to) the second serial information obtained in operation 1010 or/and operation 1020. In another embodiment, the user terminal 720 may send a result of the user authentication to the electronic device 711 even when the user authentication failed.

By verifying the identity between the first serial information and the second serial information, it is possible to prevent a plurality of electronic devices from being unlocked by one tag device.

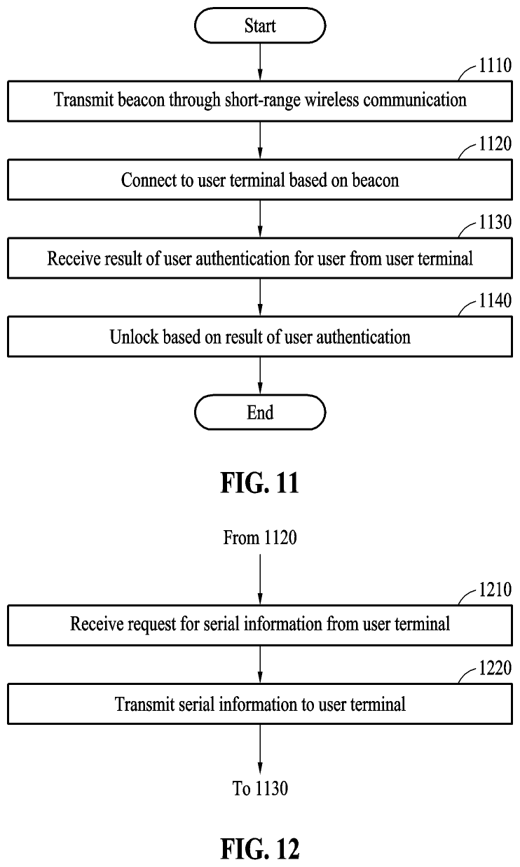

FIG. 11 is a flowchart illustrating an unlocking method based on a result of user authentication performed by an electronic device according to an example embodiment.

Operations 1110 through 1140 described below may be performed by the electronic device 711 described above with reference to FIG. 7.

In operation 1110, the electronic device 711 may transmit a beacon through short-range wireless communication. The short-range wireless communication may be, for example, Bluetooth. At this point, the electronic device 711 may have other functions locked, and only a function for short-range wireless communication may be activated.

In operation 1120, the electronic device 711 may be connected to the user terminal 720 based on the beacon. For example, the electronic device 711 may generate a link (or a channel) between the electronic device 711 and the user terminal 720.

In operation 1130, the electronic device 711 may receive a result of user authentication for a user from the user terminal 720.

In operation 1140, the electronic device 711 may be unlocked based on a result of user authentication. When the electronic device 711 is unlocked, a function for generating an aerosol may be activated. For example, a function of a heater that heats an aerosol-generating substrate in a cigarette (e.g., the cigarette 2) inserted into the electronic device 711 may be activated.

According to an example embodiment, an operation mode of the electronic device 711, before operation 1110 is performed, may be a shipping mode in which the electronic device 711 is locked. For example, as the shipping mode is activated, the electronic device 711 may be locked. A state or an operation mode in which a battery of the electronic device 711 is separated from a power supply circuit and a load of the electronic device 711 may be referred to as the shipping mode. In other words, when the shipping mode of the electronic device 711 is activated, power of the battery may not be provided to the electronic device 711.

The shipping mode may be divided into i) an auto-shipping mode of automatically shifting the operation mode of the electronic device 711 to the shipping mode by determination of the electronic device 711 without a user's command, when a voltage value of the battery is less than or equal to a preset voltage value, and ii) a forced shipping mode of shifting the operation mode to the shipping mode by a user's command regardless of the voltage value of the battery.

According to an example embodiment, when power is supplied directly to the system through a travel adapter (TA) while the shipping mode of the electronic device 711 is activated, the electronic device 711 may be turned on. When the electronic device 711 is turned on, operations 1110 through 1140 described above may be performed. When the electronic device 711 is unlocked by performing operation 1140, the operation mode of the electronic device 711 may be changed from the shipping mode to a normal mode.

FIG. 12 is a flowchart illustrating a method of transmitting serial information to a user terminal according to an example embodiment.

According to an example embodiment, operations 1210 and 1220 may be further performed after operation 1120 described above with reference to FIG. 11 is performed.

In operation 1210, the electronic device 711 may receive a request for serial information from the user terminal 720.

In operation 1220, the electronic device 711 may transmit second serial information preset in the electronic device 711 to the user terminal 720. Operation 1220 corresponds to operation 1020 of FIG. 10 where the user terminal 720 receives the second serial information from the electronic device 711.

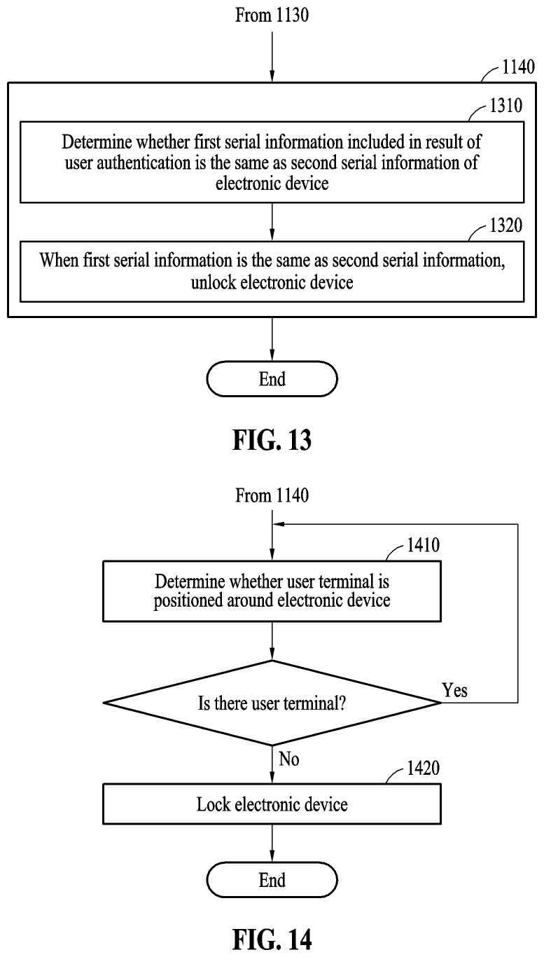

FIG. 13 is a flowchart illustrating a method of unlocking an electronic device based on serial information according to an example embodiment.

According to an example embodiment, operation 1140 described above with reference to FIG. 11 may include operations 1310 and 1320 described below.

In operation 1310, the electronic device 711 may determine whether first serial information included in a result of user authentication is the same as second serial information set in the electronic device 711. For example, the electronic device 711 may extract the first serial information obtained from the tag device 712 from the result of user authentication.

In operation 1320, when the first serial information is the same as the second serial information, the electronic device 711 may be unlocked. When the first serial information is not the same as the second serial information, it is determined that the tag 712 and the electronic device 711 do not correspond to each other, and therefore, the electronic device 711 may not be unlocked.

In an embodiment where the user terminal 720 sends the result of user authentication to the electronic device 711 only when the user authentication is successful, operations 1310 and 1320 may be omitted. Alternatively, even in that case, the electronic device 711 may perform operations 1310 and 1320 to verify the result of user authentication performed by the user terminal 720.

FIG. 14 is a flowchart illustrating a method of locking an electronic device based on a position of a user terminal according to an example embodiment.

According to an example embodiment, operations 1410 and 1420 may be further performed after operation 1140 described above with reference to FIG. 11 is performed.

In operation 1410, the electronic device 711 may determine whether the user terminal 720 is positioned around the electronic device 711. For example, the user terminal 720 may be a user terminal used to unlock the electronic device 711. As another example, the user terminal may be a different user terminal (e.g., a wearable device) additionally registered by the user after the electronic device 711 is unlocked.

According to an example embodiment, the electronic device 711 may transmit a management frame (e.g., a beacon), such that nearby devices hears the beacon and sends a response. Based on the information (e.g., unique information of a Bluetooth chip) included in the response, it may be determined whether the registered user terminal is positioned near the electronic device 711. Thereby, it may be determined whether a user, for whom the user authentication has been performed, is carrying the electronic device 711. For example, operation 1410 may be performed at a preset cycle (e.g., once a day).

In operation 1420, when it is determined that the previously registered user terminal is not positioned around the electronic device 711, the electronic device 711 may be locked. For example, when the electronic device 711 is locked, the function of the heater that heats an aerosol-generating substrate in a cigarette (e.g., the cigarette 2) inserted into the electronic device 711 may be deactivated.

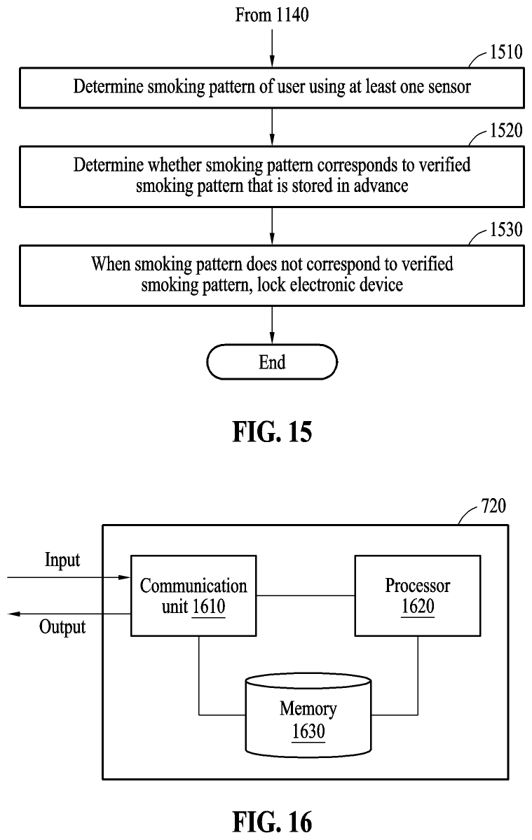

FIG. 15 is a flowchart illustrating a method of locking an electronic device based on a smoking pattern according to an example embodiment.

According to an example embodiment, operations 1510 through 1530 may be further performed after operation 1140 described above with reference to FIG. 11 is performed.

In operation 1510, the electronic device 711 may determine a current smoking pattern of a user using at least one sensor. For example, the sensor may include a pressure sensor and an airflow sensor. The smoking pattern may be, for example, a pattern of inhalation and exhalation shown from the start to the end of the smoking of the user of the electronic device 711. Examples of the inhalation pattern may include, but are not limited to, an amount of air introduced during the inhalation, an inhalation time, a time interval between inhalation, and the like. Since the inhalation pattern may be different for each user, the inhalation pattern may be used as a unique pattern representing the user.

In operation 1520, the electronic device 711 may determine whether the smoking pattern corresponds to a verified smoking pattern that is stored in advance. As the user uses the electronic device 711, the verified smoking pattern may be stored in the electronic device 711 in advance. For example, a plurality of verified smoking patterns may be provided.

In operation 1530, the electronic device 711 may be locked when the smoking pattern does not correspond to the verified smoking pattern.

Although the example embodiments of locking the electronic device 711 have been described with reference to FIGS. 14 and 15, the method of locking the electronic device 711 is not limited to the example embodiments described above. A method of verifying a user using an additional sensor, for example, by performing fingerprint recognition, iris recognition, facial recognition, or the like and locking the electronic device 711 based thereon may be used. As another example, when a user initializes the setting for the electronic device 711, the electronic device 711 may be locked. According to an example embodiment, when the electronic device 711 is initialized, the operation mode of the electronic device 711 may be switched to the shipping mode.

FIG. 16 is a diagram illustrating a configuration of a user terminal according to an example embodiment.

According to an example embodiment, the user terminal 720 described above with reference to FIG. 7 may include a communication unit (i.e., transceiver) 1610, a processor 1620, and a memory 1630.

The communication unit 1610 may be connected to the processor 1620 and the memory 1630 to transmit and receive data thereto and therefrom. The communication unit 1610 may be connected to another external device to transmit and receive data thereto and therefrom. Hereinafter, transmitting and receiving “A” may refer to transmitting and receiving “information or data indicating A.”

The communication unit 1610 may be implemented as a circuitry in the user terminal 720. For example, the communication unit 1610 may include an internal bus and an external bus. As another example, the communication unit 1610 may be an element that connects the user terminal 720 and an external device. The communication unit 1610 may be an interface. The communication unit 1610 may receive data from the external device and transmit the data to the processor 1620 and the memory 1630.

The processor 1620 may process the data received by the communication unit 1610 and data stored in the memory 1630. A processor described herein may be a hardware-implemented processing device having a physically structured circuit to execute desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 1620 may execute computer-readable code (e.g., software) stored in a memory (e.g., the memory 1630) and instructions triggered by the processor 1620.

The memory 1630 may store therein the data received by the communication unit 1610 and the data processed by the processor 1620. For example, the memory 1630 may store therein the program (or an application, or software). The program to be stored may be a set of syntaxes that are coded and executable by the processor 1620 to perform user authentication.

The memory 1630 may include, for example, at least one volatile memory, non-volatile memory, random-access memory (RAM), flash memory, hard disk drive, and optical disc drive.

The memory 1630 may store an instruction set (e.g., software) for operating the user terminal 720. The instruction set for operating the user terminal 720 may be executed by the processor 1620.

The methods according to the example embodiments described herein may be recorded in non-transitory computer-readable media including program instructions to implement various operations of the example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The devices described above may be configured to act as one or more software modules in order to perform the operations of the example embodiments, or vice versa.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network coupled computer systems so that the software is stored and executed in a distributed fashion. The software and data may be stored by one or more non-transitory computer readable recording mediums.

A number of example embodiments have been described above. Nevertheless, it should be understood that various modifications may be made to these example embodiments. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A user authentication method performed by a user terminal, the method comprising:
receiving tag information from a tag device using a near-field communication (NFC) sensor, the tag information comprising target program information;
storing a target program in the user terminal based on the target program information;
performing user authentication for a user of an electronic device based on the target program; and
transmitting a result of the user authentication to the electronic device when the user indication is successful,
wherein the electronic device is unlocked when the result of the user authentication is received.

2. The method of claim 1, wherein the target program information comprises a uniform resource locator (URL) address of the target program.

3. The method of claim 1, wherein the performing the user authentication for the user of the user terminal based on the target program comprises:
performing the user authentication using a preset authentication application programming interface (API).

4. The method of claim 1, further comprising:
receiving a beacon transmitted by the electronic device using short-range wireless communication; and
establishing a communication link with the electronic device based on the beacon.

5. The method of claim 1, wherein the tag information further comprises first serial information for confirming a correlation between the tag device and the electronic device.

6. The method of claim 5, further comprising:
receiving second serial information through a user interface; and
determining that the user authentication is successful based on the first serial information being identical to the second serial information.

7. The method of claim 5, further comprising:
receiving second serial information from the electronic device via the communication link; and
determining that the user authentication is successful based on the first serial information being identical to the second serial information.

8. The method of claim 1, wherein the electronic device is an electronic cigarette.

9. A non-transitory computer-readable storage medium storing instructions that are executable by a processor to perform the user authentication method of claim 1.

10. A user terminal, comprising:
a memory in which a program for performing user authentication is recorded; and
a processor configured to execute the program,
wherein the program include instructions that cause the processor to:
receive tag information from a tag device using a near-field communication (NFC) sensor, the tag information comprising target program information;
store a target program in the user terminal based on the target program information;
perform user authentication for a user of an electronic device based on the target program; and
transmit a result of the user authentication to the electronic device when the user authentication is successful.

11. An unlocking method performed by an electronic device, the method comprising:
transmitting a beacon using short-range wireless communication;
establishing a communication link with a user terminal based on a response to the beacon received from the user terminal;
receiving, from the user terminal, a result of user authentication for a user of the electronic device via the communication link, the result indicating that the user authentication is successful; and
unlocking the electronic device when the result of the user authentication is received.

12. The method of claim 11, further comprising:
receiving a request for serial information from the user terminal; and
transmitting the serial information to the user terminal.

13. The method of claim 11, wherein the unlocking the electronic device when the result of the user authentication is received comprises:
determining whether first serial information included in the result of the user authentication is identical to second serial information of the electronic device; and
unlocking the electronic device when the first serial information is identical to the second serial information.

14. The method of claim 11, further comprising:
determining whether the user terminal is positioned around the electronic device; and
locking the electronic device when the user terminal is not positioned around the electronic device.

15. The method of claim 11, wherein
the electronic device is an electronic cigarette, and
the method further comprises:
determining a smoking pattern of a user using at least one sensor;
determining whether the smoking pattern corresponds to a verified smoking pattern that is stored in advance; and
locking the electronic device when the determined smoking pattern does not correspond to the verified smoking pattern.
